(19) United States
(12) Patent Application Publication
(10) Pub. No.: US 2017/0061354 A1
(43) Pub. Date: Mar. 2, 2017

(54) Human Directional Quality Management System

(71) Applicant: Carlos M. Bethencourt, Miami, FL (US)

(72) Inventor: Carlos M. Bethencourt, Miami, FL (US)

(21) Appl. No.: 15/246,809

(22) Filed: Aug. 25, 2016

Related U.S. Application Data
(60) Provisional application No. 62/209,445, filed on Aug. 25, 2015.

(51) Int. Cl. G06Q 10/06; G06F 3/01; G06Q 30/02

(52) U.S. Cl. CPC G06Q 10/06393; G06Q 30/0261; G06F 3/017

(57) ABSTRACT

Human-carried signs have been used for centuries to deliver advertising messages. The effectiveness of this technique depends, among other factors, on maximizing the number of message exposures by displaying signs at optimal locations and with optimal orientations and motions. Advertising effectiveness is enhanced by attaching a suite of position, orientation and motion sensors to a sign and using the sensor outputs to quantitatively evaluate how well the actual position and orientation of the sign accords with targeted values of these parameters.

### BACKGROUND INFORMATION

Human directional advertising originated in the early 19th century in London. Since then, the concept has not evolved. It still involves a person standing or walking while displaying an advertising sign. Human directional sign carriers are also known as sign wavers, sign walkers, sign twirlers, sign spinners, or sandwich men. Today this industry employs thousands of workers across the United States. Despite the size and longevity, there is no way to determine objectively the quality of the work a sign waver is performing.

In an effort to ensure quality services, some human directional companies have created training programs for sign wavers, implemented spot checking tactics, or both. While this helps, it doesn't address the issue at stake due to the lack of continuous quality control variables.

Spot checking is biased, inconsistent and expensive. Quality is based on the manager's perception of whether the sign waver is moving correctly and standing where he/she is supposed to stand at the right time. This leads to biased results. It is inconsistent as it only takes into account brief snapshots of the sign waver's performance. For example, when the manager drives or walks by the sign location. It can be expensive as a manager's ability to supervise work is limited to the specific geography in which he/she is operating. Based on the prevalent methodologies, spot checking for quality purposes comes at a high price.

The biggest problems human directional companies and employers are facing today are the same as they were 200 years ago. They have difficulties verifying the sign waver is in the right place for the duration of his shift; and that the sign waver is moving optimally during his shift.

The lack of effective quality control has limited this industry's ability to grow. Many potential customers feel that tracking sign wavers is expensive, and poor performance could lead to brand erosion and even liabilities. Human directional companies, on the other hand, have difficulties in recognizing and promoting the best sign wavers. Retention is low and employment opportunities are limited for the workers.

### BRIEF SUMMARY OF THE INVENTION

One aspect of the invention is that it provides a method of scoring an exhibition of a human-carried sign having a display face with indicia, such as an advertising message, disposed thereon. The exhibition may be carried out at a targeted display location that may be selected well before the exhibition. The targeted location is characterized by a selected latitude and a selected longitude.

The sign exhibition may involve a targeted range of orientations of the display face for which the message on the sign is visible to a targeted audience as well as a non-targeted range of orientations considered to be of no value to the party paying for the exhibition. Each targeted orientation is characterized by respective values of pitch, yaw and roll of the display face about a selected set of axes. In examples provided hereinafter a conventional selection of axes provides that pitch is defined as rotation about a horizontal axis of the sign; yaw is defined as rotation about a vertical axis of the sign; and roll is defined as rotation about a horizontal axis perpendicular to a face of the sign.

The sign exhibition may involve a targeted range of motions of the display face, where the motions are generally selected to attract viewers' attention.

Prior to a scored exhibition a plurality of sensors is preferably attached to the sign. These sensors are preferably operable, in aggregate, to determine ones of an actual display location of the sign; an actual orientation of the display face; or a motion of the sign. The sensors may then be operated during the exhibition to determine, for each of a plurality of working periods aggregating to an exhibition period or working shift, the location, orientation and motion of the sign. For each working period a respective location score is preferably determined based on a distance between the targeted location and the respective working location. For each working period a respective orientation score is also preferably determined. This score may be based on a fraction of the working period during which the respective working orientation was within the targeted range thereof. These data may be collected and compiled in various ways to yield composite scores for a sign-waver's performance.

Thus, it is an objective of the invention to allow human directional companies and employers to identify quality improvement areas for each individual sign waver.

It is a further objective of the invention to decrease the cost of managing human directional campaigns by allowing remote management.

It is yet a further objective of the invention to improve wages for sign wavers by providing a quantitative basis for performance payment.

Management can be done while the shift is active or once the shift has been completed by using the quality control variables. To do so, the sign waver is preferably equipped with a sign, a tracking device and has Wi-Fi or telecommunications connections (such as GSM, GPRS, etc.) with a central office. The reader will recognize that these data can also be stored in the sign waver's equipment and manually returned to the central office at the end of a shift.

The data can be analyzed manually or using a processor with operating software. The preferred tracking device gathers data specific to the sign waver's location, hours worked, and quality of the orientation and movement of the sign. The data are preferably sent to a server for further analysis and to enable remote communication between the sign waver and the manager. The manager and the sign waver can use the data to see detailed performance information and to modify behaviors if necessary.

Those skilled in the art will recognize that the foregoing broad summary description is not intended to list all of the features and advantages of the invention. Both the underlying ideas and the specific embodiments disclosed in the following Detailed Description may serve as a basis for alternate arrangements for carrying out the purposes of the present invention and such equivalent constructions are within the spirit and scope of the invention in its broadest form. Moreover, different embodiments of the invention may provide various combinations of the recited features and advantages of the invention, and that less than all of the recited features and advantages may be provided by some embodiments.

### BRIEF DESCRIPTION OF THE SEVERAL VIEWS OF THE DRAWING

FIG. 1 is a partly schematic front elevational view of an instrumented sign of the invention.

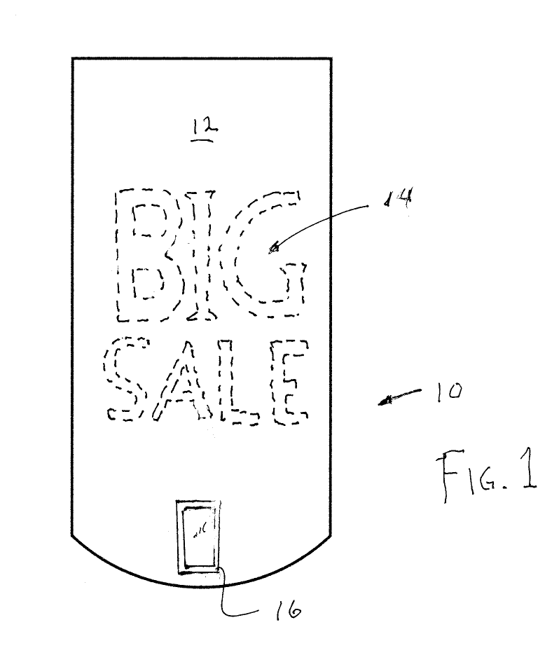

FIG. 2 is a schematic view of a sensor housing used in a preferred embodiment and of the axes associated therewith.

FIG. 3 is a schematic block diagram of sensing and analysis circuitry used by a preferred embodiment of the invention.

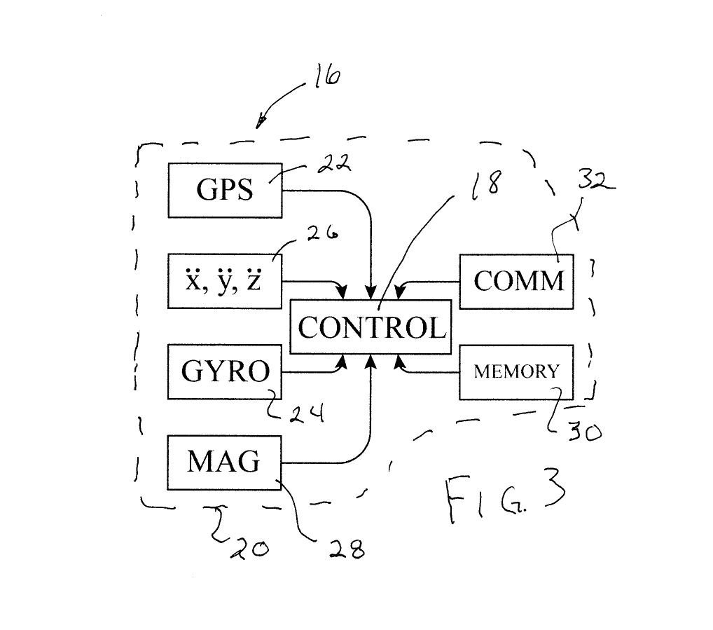

FIG. 4 is a flow chart depicting steps carried out in practicing a preferred method of the invention.

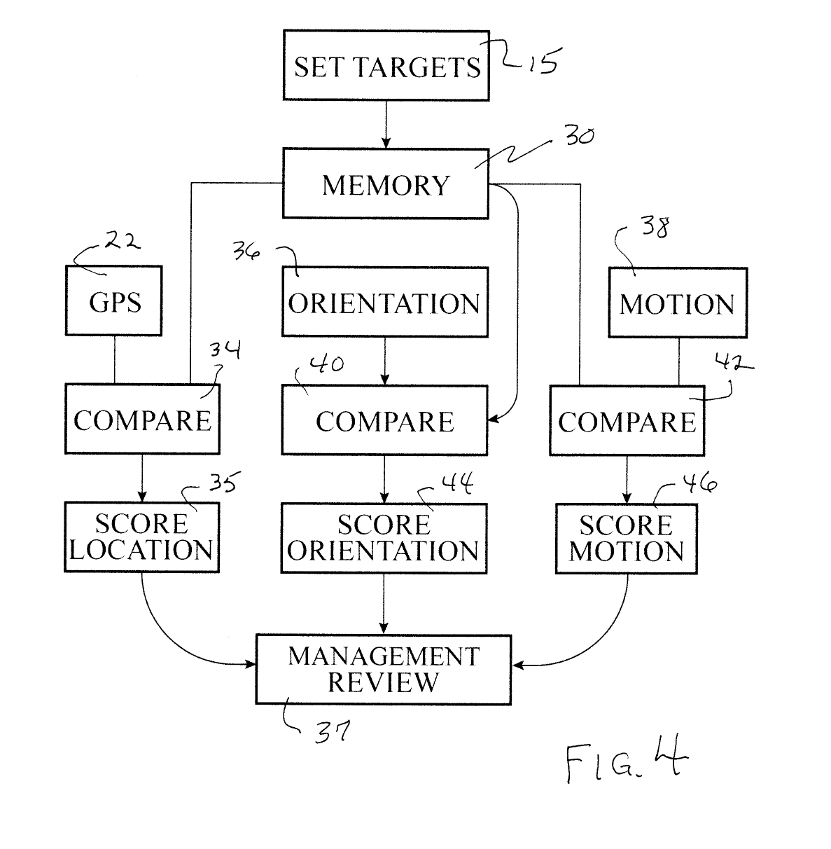

### DETAILED DESCRIPTION OF A PREFERRED EMBODIMENT

In studying this Detailed Description, the reader may be aided by noting definitions of certain words and phrases used throughout this patent document. Wherever those definitions are provided, those of ordinary skill in the art should understand that in many, if not most, instances such definitions apply both to preceding and following uses of such defined words and phrases.

Targeted locations are specific selected longitudes and latitudes at which a manager wants a sign waver(s) to exhibit a sign 10 or signs. These locations are usually, but not necessarily, associated with stores to which the sign waver is directing shoppers.

A preferred sign 10 used in a human directional campaigns may comprise a flat display face 12 having advertising indicia 14 disposed thereon. The sign is commonly a compromise between visibility, which calls for a larger displayable face, and maneuverability, which limits its maximum size. Moreover, the sign may comprise multiple flat display faces (e.g., a sign having a different advertising message on front and back sides). Moreover, the sign may have a possibly iconic shape that precludes there being a flat face. In such cases the coordinate system used to measure sign orientation and motion may be some sort of ‘best fit’ arrangement.

A sign exhibition process preferably begins with a targeting step 15 that defines a targeted location, a targeted range of orientations and a targeted range of motions (e.g., flips, tosses, spins). It will be understood that during attention-attracting sign motions the display face may not be oriented within the generally targeted range of orientations.

It should also be understood that in some circumstances one or more of the measured parameters may be omitted. For example, an exhibition on a crowded sidewalk could require a stationary sign; an exhibition inside a covered shopping mall where GPS reception was poor could measure only orientation and motion; etc.

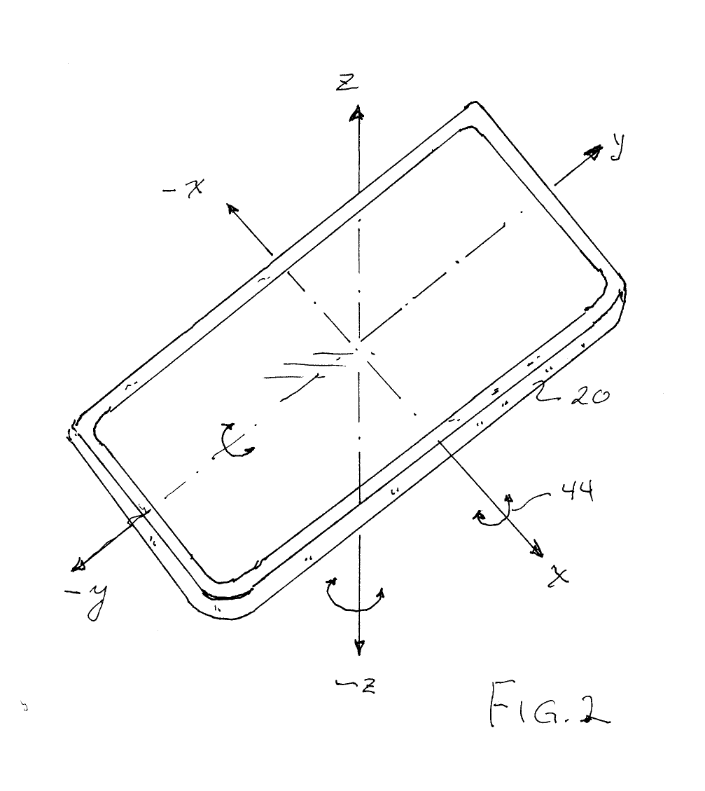

In a preferred embodiment a set of sensors 16 is attached to the sign 10 to provide location and orientation data to a computer 18. The preferred sensor array shares a common set of x, y, z axes in which the x and y axes lie in the plane of the display face 12 as depicted in FIG. 2. The reader will appreciate that this is not necessary and that suitable coordinate transform calculations can allow different sensors to have different reference systems. In a particular preferred embodiment all the sensors 16 are packaged in a single housing 20, which may be the housing of a device commonly called a smartphone. In exemplar studies reported hereinafter a variety of smartphones were used that employed the Android operating system provided by Alphabet, Inc. These comprised: an LG-D320g8, made by the LG Corporation, using Android 4.4.2; and HTC One, made by the HTC Corporation, using Android 5.0.2.

A preferred array of sensors comprises a Global Positioning System (GPS) receiver 22, a gyroscope 24, and a three-axis accelerometer 26. Other sensors, such as a magnetometer 28, may also be used and are commonly available in smartphones.

In a preferred smartphone-based implementation, data from selected sensors 16 are input to the smartphone's computer 18, which carries out a variety of analyses, as will be hereinafter discussed, and stores the results in a memory 30 from which they can be subsequently retrieved and forwarded to a management office. Although communicating data via mobile phone circuitry 32 is the preferred approach, the reader should note that the invention is not so limited and that other data collection techniques, such as physically retrieving the sign and transferring data from the sign-mounted memory to a central office machine via a wired link are within the spirit and scope of the invention.

Further, a preferred embodiment of the invention keeps a record of the hours of the shift and the sign waver's performance during that time. It does this by registering the log in and check in time of the sign waver. Log in pertains to the time the sign waver accessed the system. The sign waver selects a check-in option once he/she is at the targeted location. The check-in option verifies that the sign walker is within an acceptable range of the targeted location. This is done by comparing, in step 34, the sign waver's currently measured latitude and longitude with the latitude and longitude of the targeted location to generate, in Step 35 a location score for management review (step 37). Sign wavers within the acceptable range are allowed to proceed and begin their shifts. Sign wavers that are not may be directed to their ideal locations.

A preferred embodiment of the invention also informs the sign waver and manager about break times. Sign wavers can choose to take breaks and inform their manager. The system can be configured so that managers can also prompt the sign waver to take a break. They can set this up when creating or editing their campaign. When requesting or taking a break a preferred embodiment of the invention registers the hours and informs the manager and sign waver. In a preferred arrangement scheduled or planned breaks by the manager do not affect the sign waver's score. Unscheduled breaks may register a score of 0 for every time period specified.

It is a general goal to provide a score related to how accurately a sign waver performs at a specific targeted sign location. An advertisement printed on the sign generally has a maximum effective range that varies based on the sign's size and design. The default configuration, based on an exemplar sign used in field tests, sets this range to 100 meters. When a sign waver stands in a different position than the targeted sign location the advertisement exposure changes and only a smaller percentage of the targeted area is reached.

The targeted position may be stored in computer memory. The actual position is preferably obtained by gathering GPS data on the sign waver's location.

The maximum effective radius, R, can sometimes be considered independent of orientation. A mathematical formula to obtain the percentage of the targeted area actually covered by the sign waver in this case is:

$$\% Area covered = \{ \begin{matrix}\frac{100}{π} [ \begin{matrix}2 {cos}^{- 1} ( \frac{d}{2 R} ) - \\ sin ( 2 {cos}^{- 1} ( \frac{d}{2 R} ) )\end{matrix} ] \% ; & d \leq 2 R \\ 0 \% ; & d > 2 R\end{matrix}$$

### Where:

d: Is the distance between the actual position of the sign waver and the position of the sign location; and
R: Is the maximum radius of exposure of the advertisement.

The reader will recognize that in many cases R will vary with angle and that in these cases a more complex analysis is required. For example, consider an assigned location on a sidewalk adjacent a tall opaque wall. Here the maximum radius of exposure may be essentially zero in directions facing into the wall.

Every time a sample period elapses, in an exemplar case every 30 seconds, the data are classified and stored into a bucket. The percentage of area exposed highlights the importance of being in the right place. If a sign waver is asked to stand at the corner but the sign waver decides to stand a little further down the street, the manager will lose the advertisement exposure planned.

| TIME | EXPOSURE_COVERED |
|---|---|
| 10:14:56 | 86 |
| 10:30:40 | 90 |

During several tests sign wavers were awarded points based on the number of times the data point fell within each of the buckets. The sign waver earned a full value of a point every time the data point fell in EXPOSURE_COVERED.

In addition to measuring the sign's location, a preferred system of the invention also measures the sign's current orientation (i.e., the setting of the display face) in Step 36; and the sign's motion (i.e., changes in its orientation) in Step 38. Each of these parameters is respectively compared (steps 40, 42) with the associated target value to yield a respective parameter score 44, 46 as will be hereinafter described.

The orientation of the sign towards the road is very important measurement as it greatly determines the visibility a message may or may not have. We employ the similar logic as with the Frequency and Range of Motion variables by classifying data into buckets based on analyzed results.

To do so, we preferably employ the magnetometer 28 or compass and the accelerometer 26 that are part of the sensor suite available on many smartphones. We use the accelerometer to measure the center of gravity's acceleration point.

We preferably use rotations 44 about the X axis (Pitch) to classify the device's tilt orientation. This way we may determine whether the device's position falls within an acceptable inclination. The inclination ranges are configurable by an administrator or manager.

The system may be configured to obtain the pitch 44 every 30 seconds during a period of two minutes. We use these values to obtain the average of all the values by using the following formula:

$$Average Pitch = \frac{1}{N} {\sum }_{n = 1}^{N} p [ n ]$$

### Where:

N is the quantity of pitch data collected during the period of two minutes; and
p is the vector containing all of the pitch data gathered by the sensors.

The average pitch may be classified into three buckets determined by thresholds. In this case there is a maximum value and a minimum value for the pitch to be considered correct. These maximum and minimum values can be determined by the administrator. Here:
If Average Pitch>Maximum the sign is tilted forward too much.
If Minimum<Average Pitch<Maximum the sign is in a correct tilt position and its message can be transmitted effectively.
If Average Pitch<Minimum the sign is tilted backwards beyond a point that it is effective.

For an exemplar period of time the tilt data are

| | | | LEANING_FOR- |
|---|---|---|---|
| TIME | LEANING_BACKWARDS | GOOD | WARD |
| 10:14:56 | 27 | 63 | 10 |
| 10:30:40 | 33 | 60 | 7 |

Sign wavers may be awarded points based on the number of times a data point falls within each of the buckets. The sign waver earned a full value of a point every time the data point fell in GOOD. The sign waver received the value of 0 points every time the data point fell in LEANING_BACKWARDS or LEANING_FORWARD

A preferred embodiment of the invention measures movements performed by the sign waver. To do this the sign orientation data from the sensors are sampled, stored, classified, and later interpreted. The preferred tracker uses an accelerometer and gyroscope to collect, classify and send data.

A preferred algorithm is responsible for recording the sign's movements and classifying the resultant data into a series of buckets. The buckets store the information of movements performed by the sign waver during a specific period of time. These data are then preferably sent to a central office for further analysis in order to provide the sign waver and manager with a score.

A movement segment is determined every time that data is collected by one of the sensors. For the purpose of this test, the algorithm collected the highest absolute value of each data segment. The value obtained and the duration of the value are compared against previously determined minimum thresholds. When the values are greater than the minimum thresholds the data segment is classified as a movement. When the values are lower than the minimum thresholds, the data are discarded and will not be further analyzed.

Movements that pass the threshold test are then classified into categories by comparing measured parameters with a library of values. These parameters can be weighted so that one value in particular becomes more important to define the movement. The unique combination of different parameter weights is what determines a movement's type.
For example, we can set

γ=Σwᵢpᵢ

### Where:

p1, p2, . . . pn: are the parameters that characterize a movement obtained in the reading by sensors;
w1, w2, . . . wn: are the weight values for each parameter measured for a defined type of movement; and
y is the output value.

During the test, the following parameters were selected to define movements of interest:
p1: average linear acceleration on the X axis;
p2: average linear acceleration on the Y axis;
p3: average angular velocity about the X axis (pitch);
p4: average angular velocity about the Z axis (roll);
p5: estimated sweep angle since the beginning of the movement on the X axis; and
p6: average angular velocity about the Y axis (yaw).
   The reader may note that some motions, such as translation along the z axis, were of no interest to the subject test, and were excluded from the analysis.

Side to side movement can be from left to right, as well as up and down, with thresholds set on both distance and frequency. An exemplar test used the following weighted parameters for horizontal movements:
w1=5
w2=−2
w3=−1
w4=−1
w5=−0.5
w6=−1
   These particular values were selected because the main parameter that identifies this type of movement is p1. Hence, the weight given by w2 is high. The weight given to w2, w3, w4 are negative because p2, p3, p4 contribute negatively to the detection of this particular movement.

Correspondingly, this test used the following weighted parameters for vertical movements:
w1=−2
w2=5
w3=−1
w4=−1
w5=−0.5
w6=−1
   In this case, the parameter that best defines this movement type is p2. As a result, the weighted value for w2 is high. The weight for the parameters w1, w3, w4 corresponds to the parameters p1, p3, p4. These values are negative as they contribute negatively to this type of movement.

Top Spin comprises gyrating the device or sign forward or backwards at a specific velocity. The values are weighted the following way:
w1=0
w2=0
w3=3
w4=−2
w5=5
w6=−1
   The parameters that best define this pitch movement are p3 and p5. For this reason, the weighted values are higher for w3 and w5. In addition, by having a positive value of w5 we can ensure that each movement is being done in a specific direction.

The Shake movement comprises shaking the sign from side to side at a particular speed. The weights that characterize this movement are:
w1=−1
w2=0
w3=0
w4−3
w5=−3
w6=−5
   The parameter that identifies this movement is p4. Hence, w4 is the highest value. The weight w5 is negative to guarantee that the sign is being shaken. This ensures that that the movement is both directions as opposed to only in one direction which would not constitute a shake.

A movement called Side Spin comprises rotating the sides of the device clockwise or counter clockwise (roll). The weights for this movement are defined as:
w1=−1
w2=0
w3=0
w4−3
w5=−3
w6=5
   The parameter that identifies this movement is p6, which is why w6 has the highest value.

A movement called Angular Spin is a composite of roll and pitch and comprises rotating a sign that is tilted clockwise or counterclockwise. The weights for this movement were defined as:
w1=−1
w2=0
w3=4
w4−3
w5=−3
w6=4
   The parameters that identify this movement are p4 and p6. For this reason, w3 and w6 have the highest values.

Once the type of movement has been determined, it is time to proceed to the parameterization algorithms. Here the data obtained in the movements is compared to specific parameters in order to determine the quality of the movement. For an exemplar test, five sign movements were evaluated.

The Side to Side movement data were used to determine:
1. Frequency of Oscillation (f):
2. Average Amplitude of Oscillation (Aprom)
3. Average Inclination (Iprom)

The frequency of oscillation is given by

$$f = \frac{N}{2 ( t ( n ) - t ( 0 ) )}$$

Where:
f: is the frequency of oscillation
N: is a cycle count, which is the number of times a sign waver moves the sign towards one side and then towards the other side, returning to the original position;
t(n): is the time of the last sample; and
t(0): is the time of the first sample; where the sampling periods (in this case, 20 milliseconds) were much less than the period over which the cycle count was measured.

Average Amplitude of Oscillation (Aprom): The average amplitude of oscillation is obtained by calculating the average among the amplitudes of each oscillation cycle for the selected axis.

Average Inclination (Iprom): This parameter measures the average inclination of the sign throughout the movement. The average inclination is obtained by averaging all the inclination data within a data segment that comprises that movement.

$${I}_{prom} = {\sum }_{k = 0}^{n} i ( k )$$

### Where:

Iprom is the average inclination about the selected axis;
i(k) is the inclination value obtained by the magnetometer in the kth sample; and
n is the total number of data points within one movement.

The Top Spin movement, as noted above, comprises rotating the device forward or backwards in one direction while surpassing minimum velocity threshold. The parameters to qualify this movement are:
1. Average Velocity of Spin or Rotation (ωprom)
2. Estimated Quantity of Spins (N)

Average Velocity of Spin or Rotation (ωprom) spin is obtained by averaging z-axis data obtained from the gyroscope.

$${ω}_{prom} = \frac{1}{n} {\sum }_{k = 0}^{n} {ω}_{z} ( k )$$

### Where:

ωprom is the average angular velocity of spin;
n is the total quantity of data obtained by the accelerometer; and
ωz is the data arrangement obtained from the gyroscope in the Z axis during the movement.

To estimate the total number of spins, (N), one can use a discrete integration of data obtained by the gyroscope on the Z axis and dividing it by 2π, considering that the initial conditions of the sign are 0 or it is changed by reference angle.

$$N = \frac{1}{2 π} {\sum }_{k = 0}^{n} {ω}_{z} ( k ) \cdot [ t ( k + 1 ) - t ( k ) ]$$

### Where:

N is the estimated number of spins done by the sign in this movement;
t(k) is the time in which the kth sample was obtained;
n is the total quantity of data gathered during the movement; and
ωz is the data arrangement obtained from the gyroscope in the Z axis during the movement

The Shake movement consists of shaking the sign in two directions at greater than a minimum frequency and velocity. The parameters to qualify this movement are:
1. Oscillation Frequency (f);
2. Average Amplitude of Oscillation (Aprom); and
3. Average Tilt (Iprom); where f and Aprom are discussed hereinbefore.

The Average Tilt (Iprom) measures the sign's average inclination throughout the movement being evaluated. The average tilt is obtained by averaging all the inclination data during a particular movement.

$${I}_{prom} = {\sum }_{k = 0}^{n} i ( k )$$

### Where:

Iprom: average tilt
(k) is the inclination value obtained by the magnetometer in the kth sample; and
n is the quantity of data in a movement

The Side Spin movement consists in rotating the sign towards either side. The parameters that define this movement are:
1. Average Velocity of Spin or Rotation (ωprom); and
2. Estimated Quantity of Spins (N); both of which are discussed above with respect to a different selection of the axis relevant to the measurement.

The Angular Spin movement consists in rotating the sign in a clockwise or counter clockwise fashion while the device is tilted one way. The parameters that define this movement are:
1. Average Velocity of Spin or Rotation (ωprom)
2. Estimated Quantity of Spins (N)

The preferred range and motion algorithm obtains a sample of the acceleration about a selected axis on the device every 20 milliseconds for a period of 30 seconds. In a tested embodiment the sample acceleration parameter of 20 milliseconds was embedded inside the algorithm's code.

With the acceleration value recorded during the sampling phase, the preferred algorithm obtains the approximate velocity by employing Euler's integration principle. The algorithm integrates the acceleration value obtained during the sampling phase with a starting velocity

$$v ( n ) = {\sum }_{k = 0}^{n} a ( n ) \cdot Ts + v ( 0 )$$

### Where:

a(n) is the sample acceleration obtained during the sampling time;

v(0) is the initial velocity, in this case it is always equal to 0; and

Ts is the sampling time, which may be fixed at 20 milliseconds.

Based on these values, the preferred algorithm can calculate the range and frequency of movement for a specified period of time. In this case, the period of time was defined as every 30 seconds. Once the period of time elapses, the data obtained is averaged and classified into its respective bucket. The administrator may configure a different length of sampling time to obtain the average.

The preferred algorithm then calculates the frequency by counting the number of times a full movement is recorded. Simply put, a full movement is defined as the device's motion to the right and later to the left. To measure the completion of a full movement, the algorithm records inflexion points. An inflexion occurs every time the device measures a change or alteration in the direction it is moving. A full movement is configured to contain two inflexion points. This means that it requires the sign waver to move the sign in one direction and then back in the opposite direction. Once the sign switches directions for the second time, the second inflexion point is recorded, and new movement automatically begins.

The algorithm calculates the range of motion by averaging the difference in the velocity at both inflexion points.

Once the sampling period has concluded, in this case every 30 seconds, the data are preferably sorted into selected categories, generally herein referred to as “buckets”. In a particular example there are five buckets: Too Slow; Slow; Good; Fast; and Too Fast.

In order to classify the data one can use two parameters: “minScore” and “maxScore”. The value stored is the result of the multiplication of the frequency times the range of motion obtained by the algorithm previously described. This is preferably done the following way:

Where:

$$score = frequency \times range of motion$$

$$Too Slow \text{:} score < min Score$$

$$Slow \text{:} min Score \leq score < \frac{2}{3} min Score + \frac{1}{3} max Score$$

$$Good \text{:} \frac{2}{3} min Score + \frac{1}{3} max Score \leq score < \frac{1}{3} min Score + \frac{2}{3} max Score$$

$$Fast : \frac{1}{3} min Score + \frac{2}{3} max Score \leq score < max Score$$

$$Too Fast \text{:} max Score \leq score$$

Every time a sample period elapses, in this case every 30 seconds, the data are classified and stored by bucket. The data within each bucket are now ready to be sent to a central office for evaluation and interpretation.

Here is an example of what the data from the preferred algorithm looks like:

Too Slow: 4

Slow: 6

Good: 43

Fast: 21

Too Fast: 5

Interpreting the data can be done on any server, computer, tablet, phone, etc., or even by hand. Microsoft based SQL Server was used for the purpose of this test.

The buckets of data are received for every sampling period, in a particular case every thirty seconds. The reader will recognize that the analysis can be configured for a different period. In the case of the experiment the server is configured to analyze a bucket every two minutes. This means that each bucket will contain four data points, for a total of sixteen data points.

A score is calculated based on the percentage of time the sign waver moved within an acceptable range of motions. This means that the highest score an individual can earn is 100. It is the equivalent of an instrumented sign moving within the acceptable range for motion 100% of the time during the specific shift.

In this case, each data point is worth 6.25 points, which provides for up to a total of 100 for this evaluation period. We can configure the buckets to specify any length of time. This means that if we chose 4 minutes instead of 2 minutes, each data point would be worth 3.125 points. The maximum sum of all the data points within an evaluation period is preferably 100. As a result, the sign waver's score will be less than or equal to 100.

During tests, sign wavers were awarded points based on the number of times the data point fell within each of the buckets. The sign waver earned a full value of a point every time the data point fell in the Good bucket. The sign waver earned 0.5 value of a point every time the data point fell within the slow or fast bucket. The sign waver earned 0 points every time the data point fell within the too slow or too fast bucket. The points associated with each bucket can be configured by the manager.

Here is data obtained during our test to illustrate how the score is calculated:

| TIME | TOOSLOW | SLOW | GOOD | FAST | TOOFAST |
|---|---|---|---|---|---|
| 10:14:56 | 29 | 17 | 52 | 0 | 0 |
| 10:30:39 | 10 | 3 | 62 | 24 | 0 |

The score for this person from 10:14:56 to 10:30:39 is (52*1)+(17*0.5)+(9*0)=60.5

The score, as well as a detailed report of the movement, is preferably displayed to the manager and to the person waving the sign. Score formats and prompt alerts may vary.

Although the present invention has been described with respect to several preferred embodiments, many modifications and alterations can be made without departing from the invention. Accordingly, it is intended that all such modifications and alterations be considered as being within the spirit and scope of the invention as defined in the attached claims.

1) A method of scoring an exhibition of a human-carried sign, the method comprising the steps of:
a) providing the sign having a display face with indicia disposed thereon;
b) attaching to the sign a plurality of sensors operable, in aggregate, to determine an actual display location of the sign and an actual orientation of the display face;
c) defining, for a targeted display location characterized by a selected latitude and a selected longitude, a targeted range of orientations of the display face, wherein each orientation in the targeted range is characterized by respective values of pitch, yaw and roll of the display face about a selected set of axes;
d) operating the sensors during a working period to determine at least one respective actual location of the sign and at least one respective actual orientation of the display face;
e) generating at least one location score based on a distance between the targeted location and the respective actual location; and
f) generating at least one orientation score based on a fraction of the working period during which the respective actual orientation was within the targeted range thereof.

2) The method of claim 1 wherein: the step of operating the sensors is repeated for each of a plurality of the working periods aggregating to an exhibition period.

3) The method of claim 1 wherein the plurality of sensors comprises a Global Positioning Satellite receiver providing a time signal used to demarcate the working period.

4) The method of claim 1 wherein the plurality of sensors comprises a gyroscope and a three axis accelerometer, each having respective digital outputs to a computer providing a time signal used to demarcate the working period.

5) The method of claim 1 further comprising the additional steps of:
g) defining, for the targeted display location, a targeted range of motions of the display face, wherein each motion is characterized by respective values of change in pitch, yaw and roll of the display face about the respective axes;
h) measuring, by means of the sensors, a motion between two of the orientations; and
i) generating a motion score based on a fraction of the working period during which the motion is within the targeted range.

6) The method of claim 1 wherein each of the generating steps is carried out by a computer fixedly attached to the sign.

7) A method of scoring an exhibition of a human-carried sign, the method comprising the steps of:
a) providing the sign having a display face with indicia disposed thereon;
b) defining, for a targeted display location characterized by a selected latitude and a selected longitude, a targeted range of motions of the display face, wherein each motion is characterized by respective values of change in pitch, yaw and roll of the display face about a selected set of axes;
b) attaching to the sign a plurality of sensors operable, in aggregate, to determine an actual display location of the sign and at least one actual motion of the display face;
c) operating the sensors during a working period to determine an actual location of the sign and at least one actual motion of the display face;
d) generating a location score based on a distance between the targeted location and the actual location; and
e) generating a motion score based on a fraction of the working period during which the respective actual motion is within the targeted range thereof.

8) The method of claim 7 wherein the sensors are operated for each of a plurality of working periods aggregating to an exhibition period, and wherein at least one location score and at least one motion score are determined for each of the working periods.

9) The method of claim 7 further comprising the steps of:
f)) defining, for the targeted display location, a targeted range of orientations of the display face, wherein each orientation in the targeted range is characterized by respective values of pitch, yaw and roll of the display face about the axes;
g) determining, by operating the sensors during a working period, an actual orientation of the display face; and
h) generating an orientation score based on a fraction of the working period during which the actual orientation was within the targeted range thereof.

10) A method of scoring an exhibition of a human-carried sign, the method comprising the steps of:
a) providing the sign having a display face with indicia disposed thereon;
b) defining a targeted range of orientations of the display face, wherein each orientation is characterized by respective values of pitch, yaw and roll of the display face about a selected set of axes;
c) defining a targeted range of motions of the display face, wherein each motion is characterized by a respective rate of change of pitch, yaw and roll of the display face about the selected set of axes;
d) attaching to the sign a plurality of sensors operable, in aggregate, to determine an actual orientation of the display face and an actual motion of the display face;
e) operating the sensors to determine, for a working period, an actual orientation of the display face and an actual motion of the display face;
f) generating an orientation score based on a fraction of the working period during which the actual orientation is within the targeted range thereof; and
g) generating a motion score based on a fraction of the working period during which the actual motion was within the targeted range thereof.

11) The method of claim 10 wherein the sensors are operated for each of a plurality of working periods within an exhibition period, and wherein a respective orientation score and a respective motion score are determined for each of the working periods.

12) The method of claim 10 further comprising the steps of:
h) defining a targeted display location characterized by a selected latitude and a selected longitude;
i) operating the sensors during a working period to determine a working location of the sign;
j) generating, for the working period, a location score base on a distance between the targeted location and the respective working location.
